(19) United States
(12) Patent Application Publication
(10) Pub. No.: US 2025/0077354 A1
(43) Pub. Date: Mar. 6, 2025

(54) ENCODING METHOD AND APPARATUS FOR RAID6 DISK ARRAY, DECODING METHOD AND APPARATUS FOR RAID6 DISK ARRAY, AND MEDIUM

(71) Applicant: SUZHOU METABRAIN INTELLIGENT TECHNOLOGY CO., LTD., Suzhou, Jiangsu (CN)

(72) Inventors: Ruizhen WU, Suzhou, Jiangsu (CN); Xu ZHANG, Suzhou, Jiangsu (CN); Xiaowei WANG, Suzhou, Jiangsu (CN); Lin WANG, Suzhou, Jiangsu (CN); Jingjing CHEN, Suzhou, Jiangsu (CN); Yongxing ZHANG, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 18/724,067

(22) PCT Filed: Feb. 23, 2023
(86) PCT No.: PCT/CN2023/077973

§ 371 Date: Jun. 25, 2024

(30) Foreign Application Priority Data
Jul. 26, 2022 (CN) 202210887332.0

(51) Int. Cl. G06F 11/10

(52) U.S. Cl. CPC G06F 11/1096

(57) ABSTRACT

Provided are an encoding method and apparatus for an RAID6 disk array, a decoding method and apparatus for an RAID6 disk array, and a medium. The encoding method comprises: dividing all disks in a RAID6 disk array into two groups to obtain a first disk group and a second disk group; pairing all stripes of the RAID6 disk array to obtain several stripe pairs; and calculating two parity codes of each strip in the several stripe pairs according to a first rule and a second rule.

### CROSS-REFERENCE TO RELATED APPLICATION

This disclosure claims the priority based on Chinese Patent Application No. 202210887332.0, filed with the Chinese Patent Office on Jul. 26, 2002 and entitled “Encoding Method and Device For RAID6 Disk Array, Decoding Method and Device for RAID6 Disk Array, and Medium”, which is incorporated herein by reference in its entirety.

### TECHNICAL FIELD

Embodiments of the present disclosure relate to the storage field, and in particular, to an encoding method and apparatus for an RAID6 disk array, a decoding method and apparatus for an RAID6 disk array, and a medium.

### BACKGROUND

With the rapid development of communication technology and network science, there has been an exponential explosion in digital information, posing significant challenges to data storage technology. The reliability of data in storage systems and the energy consumption of storage systems are increasingly drawing people's attention. In the face of such massive data volumes today, there is an inverse relationship between the reliability of data in storage systems and the number of components contained within them. That is to say, the more components there are in a storage system, the lower the reliability of the data stored within it. According to relevant surveys, in an Internet data center composed of 600 disks, approximately 30 disks are reported to fail each month, and in a large-scale storage system, the decrease in data reliability caused by disk failures is a significant issue. In response, people have started researching relevant fault-tolerant techniques.

In 1988, Patterson and others from the University of California, Berkeley, proposed the RAID structure, which became a key technology for improving storage space. RAID (Redundant Arrays of Independent Disks) refers to disk arrays with redundancy capabilities. These arrays are created by combining multiple independent disks to form a single, large-capacity disk group. By using the RAID storage technology, storage capacity can be significantly increased, the system's input/output request processing capability is improved, and data reliability is improved by using a data distributed storage technique, a parallel access method and an information redundancy technique. After the design concept of RAID was proposed, it was quickly adopted by the industry. RAID technology, as a high-performance and highly reliable storage technology, has now been widely applied in people's production and daily life. RAID mainly utilizes techniques such as data striping, data parity, and mirroring to achieve strong performance, higher reliability, better fault tolerance, and high scalability. According to different data application requirements, strategies and architectures using or combining the three techniques may be used. Therefore, according to different strategies and architectures, RAID may be classified into different levels: RAID0, 1, 5, 6, 10.

RAID0 is the earliest RAID mode, known as Data Striping technology. RAID0 is the simplest form of constructing a disk array, requiring only 2 or more hard disks. It has low cost and can enhance the performance and throughput of the entire disk array. RAID0 does not provide redundancy or error recovery capability, but it has the lowest implementation cost. The simplest way to implement RAID0 is to connect N identical hard disks either through a hardware method using an intelligent disk controller or through a software method using disk drivers within the operating system, to create a large volume set. During use, computer data is sequentially written to each hard disk, and its greatest advantage is that it can effectively increase the storage capacity of the hard disks by a multiple. If three 80 GB hard disks are used to configure a RAID0 array, the disk capacity will be 240 GB. In terms of speed, it is exactly the same as that of a single hard disk. The major drawback is that if any one hard disk fails, the entire system will be damaged, and the reliability will be only 1/N of a single hard disk.

RAID1 is known as disk mirroring, where the principle involves mirroring the data from one disk onto another. This means that while data is being written to one disk, a mirror image of that data is simultaneously created on another idle disk. This ensures maximum system reliability and recoverability without compromising performance. As long as at least one disk in any pair of mirror disks in the system can be used, the system can operate normally, even if problems occurs in half of the total number of hard disks. When a hard disk fails, the system will ignore that drive and instead utilize the remaining mirror disk to read and write data, providing excellent disk redundancy capability. Although this approach ensures absolute data safety, it also comes with a significant increase in costs due to the disk utilization rate of 50%, for example, with four 80 GB capacity hard disks, the available disk space would only be 160 GB. In addition, a RAID system in which a hard disk failure occurs is no longer reliable, and a damaged hard disk is replaced in a timely manner; otherwise, a problem also occurs in the remaining mirror disk, and the entire system will crash. After a new disk is replaced, it will take a long time to synchronize the mirror, and external access to the data will not be affected. However, the performance of the entire system may decrease during this time. Therefore, the RAID1 is often used in situations of storing critical and important data.

RAID5 (independent disk structure of distributed parity check). Its parity check codes exist on all disks, where p0 represents the parity check value of the 0th stripe, and the meaning is the same for others. The read efficiency of RAID5 is high, while the write efficiency is moderate, and the block-based collective access efficiency is good. As the parity check codes are on different disks, reliability is improved. However, it doesn't address the parallelism of data transmission well, and the design of controllers is quite challenging. For RAID5, most data transfers involve operations on only one disk, enabling parallel operations. In RAID5, there is a “write penalty,” meaning that each write operation generates four actual read/write operations: two reads for old data and parity information, and two writes for new data and parity information.

RAID6 is an independent disk structure with two types of distributed storage parity check codes. RAID6 extends RAID5 and is mainly used in situations where data must be absolutely error-free. Due to the introduction of the second parity check value, it requires N+2 disks, making the design of controllers extremely complex. However, it enhances the data reliability of the disk array. It requires more space to store the parity check values, and it also incurs higher performance loss during write operations. RAID6 technology is widely used in today's distributed storage servers. RAID6 can recover from the failure of up to two blocks, but each data recovery operation is still constrained by the speed limitations of reading a large amount of data from each disk. Therefore, there is an urgent need to improve the encoding and decoding methods for a RAID6 disk array.

### SUMMARY

In view of this, it is necessary to solve the problem of data recovery limitations due to the traditional RAID6 encoding and decoding methods being constrained by data read volume. The embodiments of the present disclosure provide an encoding method for a RAID6 disk array, a decoding method for a RAID6 disk array, an encoding apparatus for a RAID6 disk array, a decoding apparatus for a RAID6 disk array, a computer device, and a non-volatile storage medium.

According to a first aspect of the embodiments of the present disclosure, an encoding method for a RAID6 disk array is provided, wherein the encoding method comprises:
all the disks in the RAID6 disk array are divided into two groups to obtain a first disk group and a second disk group;
all stripes of the RAID6 disk array are paired to obtain several stripe pairs; and
two parity codes of each strip in the several stripe pairs are calculated according to a first rule and a second rule, wherein the first rule is that the result of XOR operations on each piece of data from the first disk group and each piece of data from the second disk group in each stripe is equal to zero, and the second rule is that the result of XOR operations on the product of each piece of data from the first disk group multiplied by the corresponding disk number in one stripe of a stripe pair, and the product of each piece of data from the second disk group multiplied by the corresponding disk number in the other stripe of the same stripe pair, is equal to zero.

In some embodiments, the encoding method further comprises:
in response to the total number of stripes in the RAID6 disk array being an odd number, two parity codes of an unpaired stripe are calculated according to the first rule and a third rule, wherein the third rule is that the result of XOR operations on the product of each piece of data from the first disk group multiplied by the corresponding disk number and the product of each piece of data from the second disk group multiplied by the corresponding disk number in the same stripe is equal to zero.

In some embodiments, the step of dividing all disks in a RAID6 disk array into two groups to obtain a first disk group and a second disk group comprises:
the total number of disks of the RAID6 disk array is acquired;
in response to the total number of disks being an even number, all disks constituting the RAID6 disk array are equally divided into two groups; and
in response to the total number of disks being an odd number, all disks constituting the RAID6 disk array are divided into two groups, with one group containing one more disk than the other.

In some embodiments, the step of equally dividing all disks constituting the RAID6 disk array into two groups comprises:
the disk arrangement sequence of the RAID6 disk array is acquired; and
the first half and the second half of the disk arrangement sequence are divided into separate groups.

In some embodiments, the step of equally dividing all disks constituting the RAID6 disk array into two groups comprises:
the disk arrangement sequence of the RAID6 disk array is acquired; and
the disks corresponding to all odd-numbered positions and the disks corresponding to all even-numbered positions in the disk arrangement sequence are divided into two groups.

In some embodiments, the step of dividing all disks constituting the RAID6 disk array into two groups, with one group containing one more disk than the other comprises:
the disk arrangement sequence of the RAID6 disk array is acquired; and
the disks corresponding to all odd-numbered positions and the disks corresponding to all even-numbered positions in the disk arrangement sequence are divided into two groups.

In some embodiments, the step of pairing all stripes of the RAID6 disk array to obtain several stripe pairs comprises:
the total number of stripes and the stripe arrangement sequence of the RAID6 disk array is acquired;
in response to the total number of the stripes being an even number, all the stripes are paired based on the stripe arrangement sequence in a manner where every two consecutive stripes form a pair; and
in response to the total number of the strips being odd, the remaining stripes, excluding the first or last stripe, are paired based on the stripe arrangement sequence in a manner where every two consecutive stripes form a pair.

In some embodiments, the load balancing of the RAID6 disk array can be achieved in any of the following ways: left rotation alignment, left rotation misalignment, right rotation alignment, and right rotation misalignment.

According to a second aspect of the embodiments of the present disclosure, decoding method for a RAID6 disk array is provided, wherein the RAID6 disk array is encoded by using the described encoding method, and the decoding method comprises:
in response to a single disk error occurring in the RAID6 disk array, the disk group to which the single disk error belongs is determined;
in response to the stripe corresponding to the single disk error belonging to the several stripe pairs, first decoded data is read in a manner where the minimum decoding unit consists of two stripes, wherein the first decoded data comprises: all data from the other disks in the disk group to which the single disk error belongs, where the single disk error did not occur, on both stripes of one stripe pair, as well as all data from each disk in the disk group where the single disk error did not occur, on one stripe of the same stripe pair; and
decoding is performed based on the first rule, the second rule, and the first decoded data to obtain recovered data.

In some embodiments, the decoding method further comprises:

in response to the stripe corresponding to the single disk error not belonging to any stripe pair, second decoded data is read in a manner where the minimum decoding unit consists of one stripe, wherein the second decoded data comprises all data from the other disks, excluding the disk where the single disk error occurred, on the stripe; and
decoding is performed based on the first rule, the third rule, and the second decoded data to obtain recovered data.

According to a third aspect of the embodiments of the present disclosure, an encoding apparatus for a RAID6 disk array is provided, wherein the encoding apparatus comprises:
a disk grouping module, configured to divide all disks in a RAID6 disk array into two groups to obtain a first disk group and a second disk group;
a stripe pairing module, configured to pairing all stripes of the RAID6 disk array to obtain several stripe pairs; and
a calculation module, configured to calculate two parity codes of each strip in the N stripe pairs according to a first rule and a second rule, wherein the first rule is that the result of XOR operations on each piece of data from the first disk group and each piece of data from the second disk group in each stripe is equal to zero, and the second rule is that the result of XOR operations on the product of each piece of data from the first disk group multiplied by the corresponding disk number in one stripe of a stripe pair, and the product of each piece of data from the second disk group multiplied by the corresponding disk number in the other stripe of the same stripe pair, is equal to zero.

According to a fourth aspect of the embodiments of the present disclosure, wherein the RAID6 disk array is encoded by using the described encoding apparatus, and the decoding apparatus comprises:
a determination module, configured to, in response to a single disk error occurring in the RAID6 disk array, determine the disk group to which the single disk error belongs;
a first reading module, configured to, in response to the stripe corresponding to the single disk error belonging to the several stripe pairs, read first decoded data in a manner where the minimum decoding unit consists of two stripes, wherein the first decoded data comprises: all data from the other disks in the disk group to which the single disk error belongs, where the single disk error did not occur, on both stripes of one stripe pair, as well as all data from each disk in the disk group where the single disk error did not occur, on one stripe of the same stripe pair; and
a first decoding module, configured to perform decoding based on the first rule, the second rule, and the first decoded data to obtain recovered data.

In some embodiments, the decoding apparatus further comprises:
a second reading module, configured to, in response to the stripe corresponding to the single disk error not belonging to any stripe pair, second decoded data is read in a manner where the minimum decoding unit consists of one stripe, wherein the second decoded data comprises all data from the other disks, excluding the disk where the single disk error occurred, on the stripe; and
a second decoding module, configured to perform decoding based on the first rule, the third rule, and the second decoded data to obtain recovered data.

According to a fifth aspect of the embodiments of the present disclosure, a computer device is further provided, wherein the computer device comprises:
at least one processor; and
a memory, wherein the memory stores computer programs that are executable by the processor, and when the computer programs are executed, the processor performs the described encoding method for a RAID6 disk array or the described decoding method for a RAID6 disk array.

According to a sixth aspect of the embodiments of the present disclosure, a non-volatile readable storage medium is further provided, wherein the non-volatile readable storage medium stores computer programs, wherein when the computer programs are executed by a processor, the processor performs the described encoding method for a RAID6 disk array or the described decoding method for a RAID6 disk array.

The encoding method for a RAID6 disk array comprises: all disks in a RAID6 disk array are divided into two groups to obtain a first disk group and a second disk group; all stripes of the RAID6 disk array are paired to obtain several stripe pairs; and finally two parity codes of each strip in the several stripe pairs are calculated according to a first rule and a second rule. This method enables cross-coding of two stripes belonging to the same stripe pair based on disk grouping, enriching the encoding and decoding methods of RAID 6 disk arrays, reducing the amount of data required to be read for data recovery in the event of a single disk error, and enhancing the performance of RAID6.

In addition, embodiments of the present disclosure further provide a decoding method for a RAID6 disk array, an encoding apparatus for a RAID6 disk array, a decoding apparatus for a RAID6 disk array, a computer device, and a non-volatile readable storage medium, and these can also achieve the described technical effects, and details are not described herein again.

### BRIEF DESCRIPTION OF THE DRAWINGS

To describe the technical solutions in the embodiments of the present disclosure or in the prior art more clearly, the following briefly introduces the accompanying drawings required for describing the embodiments or the prior art. Apparently, the accompanying drawings in the following description show merely some embodiments of the present disclosure, and a person skilled in the art may still derive other embodiments from these accompanying drawings without creative efforts.

FIG. 1 is a schematic flowchart of an encoding method for a RAID6 disk array according to an embodiment of the present disclosure;

FIG. 2 is a schematic flowchart of a decoding method for a RAID6 disk array according to another embodiment of the present disclosure;

FIG. 3 is a schematic diagram of the configuration of a RAID6 with 6 disks in a left rotation misalignment state according to another embodiment of the present disclosure;

FIG. 4 is a schematic diagram of the configuration of a RAID6 with 6 disks in an odd number of stripes according to another embodiment of the present disclosure;

FIG. 5 is a schematic structural diagram of an encoding apparatus for a RAID6 disk array according to another embodiment of the present disclosure;

FIG. 6 is a schematic structural diagram of a decoding apparatus for a RAID6 disk array according to another embodiment of the present disclosure;

FIG. 7 is an internal structural diagram of a computer device according to another embodiment of the present disclosure.

### DETAILED DESCRIPTION OF THE EMBODIMENTS

To make the purpose, technical solutions, and advantages of the embodiments of the present disclosure clearer, the following describes the embodiments of the present disclosure in detail in combination with optional embodiments and with reference to the accompanying drawings.

It is noted that, in the embodiments of the present disclosure, all expressions of “first” and “second” are used to distinguish two entities or parameters with the same name but different characteristics. It can be determined that “first” and “second” are merely for convenience of description, and should not be understood as limitations to the embodiments of the present disclosure, and the subsequent embodiments will no longer individually explain this point.

In an embodiment, referring to FIG. 1, the embodiment of the present disclosure provides an encoding method 100 for a RAID6 disk array, which optionally comprises the following steps:
step 101: all the disks in the RAID6 disk array are divided into two groups to obtain a first disk group and a second disk group;
step 102, all stripes of the RAID6 disk array are paired to obtain several stripe pairs; and
step 103, two parity codes of each strip in the several stripe pairs are calculated according to a first rule and a second rule, wherein the first rule is that the result of XOR operations on each piece of data from the first disk group and each piece of data from the second disk group in each stripe is equal to zero, and the second rule is that the result of XOR operations on the product of each piece of data from the first disk group multiplied by the corresponding disk number in one stripe of a stripe pair, and the product of each piece of data from the second disk group multiplied by the corresponding disk number in the other stripe of the same stripe pair, is equal to zero.

The encoding method for a RAID6 disk array comprises: all disks in a RAID6 disk array are divided into two groups to obtain a first disk group and a second disk group; all stripes of the RAID6 disk array are paired to obtain several stripe pairs; and finally two parity codes of each strip in the several stripe pairs are calculated according to a first rule and a second rule. This method enables cross-coding of two stripes belonging to the same stripe pair based on disk grouping, enriching the encoding and decoding methods of RAID 6 disk arrays, reducing the amount of data required to be read for data recovery in the event of a single disk error, and enhancing the performance of RAID6.

In some embodiments, the encoding method further comprises:
in response to the total number of stripes in the RAID6 disk array being an odd number, two parity codes of an unpaired stripe are calculated according to the first rule and a third rule, wherein the third rule is that the result of XOR operations on the product of each piece of data from the first disk group multiplied by the corresponding disk number and the product of each piece of data from the second disk group multiplied by the corresponding disk number in the same stripe is equal to zero.

In some embodiments, the step of dividing all disks in a RAID6 disk array into two groups to obtain a first disk group and a second disk group comprises:
the total number of disks of the RAID6 disk array is acquired;
in response to the total number of disks being an even number, all disks constituting the RAID6 disk array are equally divided into two groups; and
in response to the total number of disks being an odd number, all disks constituting the RAID6 disk array are divided into two groups, with one group containing one more disk than the other.

In some embodiments, the step of equally dividing all disks constituting the RAID6 disk array into two groups comprises:
the disk arrangement sequence of the RAID6 disk array is acquired; and
the first half and the second half of the disk arrangement sequence are divided into separate groups.

In some embodiments, the step of equally dividing all disks constituting the RAID6 disk array into two groups comprises:
the disk arrangement sequence of the RAID6 disk array is acquired; and
the disks corresponding to all odd-numbered positions and the disks corresponding to all even-numbered positions in the disk arrangement sequence are divided into two groups.

In some embodiments, the step of dividing all disks constituting the RAID6 disk array into two groups, with one group containing one more disk than the other comprises
the disk arrangement sequence of the RAID6 disk array is acquired; and
the disks corresponding to all odd-numbered positions and the disks corresponding to all even-numbered positions in the disk arrangement sequence are divided into two groups.

In some embodiments, the step of pairing all stripes of the RAID6 disk array to obtain several stripe pairs comprises:
the total number of stripes and the stripe arrangement sequence of the RAID6 disk array is acquired;
in response to the total number of the stripes being an even number, all the stripes are paired based on the stripe arrangement sequence in a manner where every two consecutive stripes form a pair; and
in response to the total number of the strips being odd, the remaining stripes, excluding the first or last stripe, are paired based on the stripe arrangement sequence in a manner where every two consecutive stripes form a pair.

In some embodiments, the load balancing of the RAID6 disk array can be achieved in any of the following ways: left rotation alignment, left rotation misalignment, right rotation alignment, and right rotation misalignment.

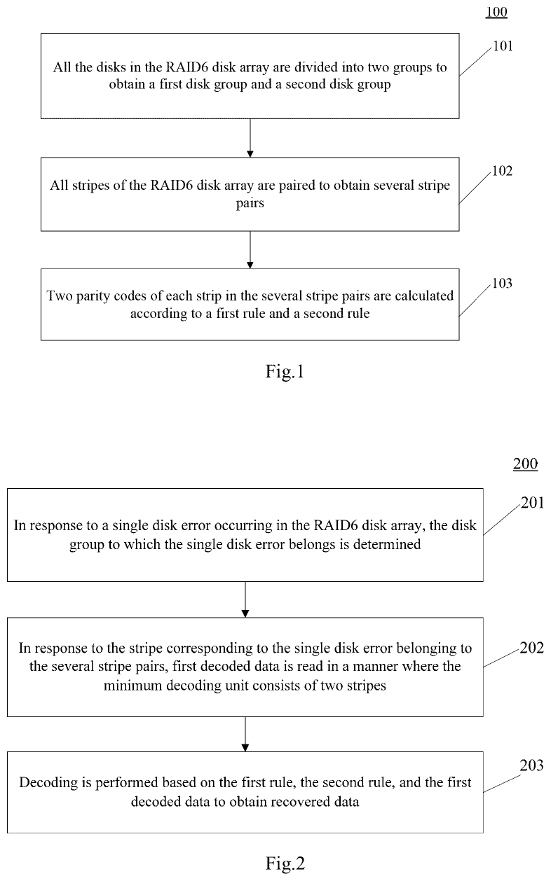

In still another embodiment, referring to FIG. 2, the embodiment of the present disclosure further provides a decoding method 200 for a RAID6 disk array, wherein the RAID6 disk array is encoded by using the described encoding method, and the decoding method comprises:
step 201, in response to a single disk error occurring in the RAID6 disk array, the disk group to which the single disk error belongs is determined;
step 202, in response to the stripe corresponding to the single disk error belonging to the several stripe pairs, first decoded data is read in a manner where the minimum decoding unit consists of two stripes, wherein the first decoded data comprises: all data from the other disks in the disk group to which the single disk error belongs, where the single disk error did not occur, on both stripes of one stripe pair, as well as all data from each disk in the disk group where the single disk error did not occur, on one stripe of the same stripe pair; and
step 203: decoding is performed based on the first rule, the second rule, and the first decoded data to obtain recovered data.

The described decoding method for a RAID6 disk array allows for the recovery of erroneous data without the need to read all the data in the event of a single disk error, reducing the amount of data required to be read for data recovery in the event of a single disk error, thereby enhancing RAID6 performance.

In some embodiments, the decoding method further comprises:
in response to the stripe corresponding to the single disk error not belonging to any stripe pair, second decoded data is read in a manner where the minimum decoding unit consists of one stripe, wherein the second decoded data comprises all data from the other disks, excluding the disk where the single disk error occurred, on the stripe; and
decoding is performed based on the first rule, the third rule, and the second decoded data to obtain recovered data.

In still another embodiment, the design of RAID6 aims to ensure that after the RAID group is assembled, errors in any two or one of the disk groups can be recovered. It is the most widely used erasure coding scheme in today's general storage products. However, for the error recovery of the RAID6, all the remaining data needs to be read for calculation, and therefore performance comparisons between different implementation solutions mainly focuses on the speed of data encoding and decoding. In actual application scenarios, although RAID6 can guarantee recovery from any two arbitrary errors, statistical data from real-world scenarios indicates that single-error situations account for 99.75% of all errors. Therefore, regardless of the optional implementation solution of any RAID, the core speed improvement should focus on enhancing performance in single-error scenarios. To facilitate understanding of the solutions according to the embodiments of the present disclosure, the algorithm principles of traditional RAID6, and the encoding method for a RAID6 disk array and decrypting method for a RAID6 disk array according to the embodiments of the present disclosure are separately described in this embodiment.

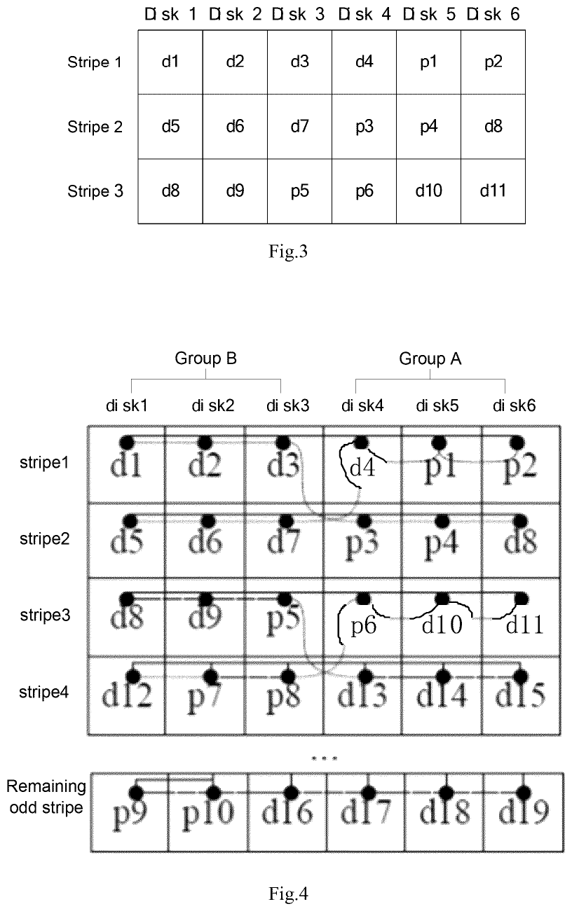

First part: the algorithm principles of traditional RAID6 are as follows:
the algorithm principles used in traditional RAID6 are:

$$\{ \begin{matrix}{d}_{1} ⊕ {d}_{2} ⊕ … ⊕ p ⊕ q = 0 \\ {d}_{1} ⊕ 2 {d}_{2} ⊕ … ⊕ xp ⊕ yq = 0\end{matrix} ; \qquad equation ( 1 )$$

wherein The p and q in equation (1) p and q in equation (1) represent the two parity codes configured under RAID6, and recovery from any two errors within the RAID6 group can be achieved by using p and q. In equation (1), x and y represent the positions of p and q respectively, determined by the striping relationship within the disks configuring the RAID group; and during server configuration, in order to uniform IO (Input Output) pressure across all disks and achieve load balancing, it is generally necessary to evenly distribute the load on the disks by using a load balancing algorithm. Assuming that there are a total of 6 disks, when RAID6 is configured, with 4 disks for user data and 2 disks for parity, in order to achieve load balancing, we choose to use a left-rotation non-aligned method for illustration, with the configuration as shown in FIG. 3. Correspondingly, other common methods for load balancing comprises left-rotation aligned, right-rotation non-aligned, and right-rotation aligned methods; which are similar in actual performance, and are randomly used in actual applications. Therefore, the left-rotation non-aligned method is used as an example herein for illustration. Because the algorithmic relationship of RAID6 is based on based on the Vandermonde algorithm, optional implementations can be configured entirely based on position, and an encoding/decoding method implemented in this way is more friendly to the hardware architecture and firmware configuration of an actual product. Taking the situation of FIG. 3 as an example, the relationship obtained for RAID6 under the position relationship configuration is:

$$1 \text{?} \{ \begin{matrix}d 1 ⊕ d 2 ⊕ d 3 ⊕ d 4 ⊕ p \text{?} ⊕ p 2 = 0 \\ d 1 ⊕ 2 d 2 ⊕ 3 d 3 ⊕ 4 d 4 ⊕ 5 p \text{?} ⊕ 6 p 2 = 0\end{matrix} \qquad equation ( 2 )$$

$$2. \{ \begin{matrix}d 5 ⊕ d 6 ⊕ d 7 ⊕ p 3 ⊕ p 4 ⊕ d \text{?} = 0 \\ d 5 ⊕ 2 d 6 ⊕ 3 d 7 ⊕ 4 p 3 ⊕ 5 p 4 ⊕ 6 d 8 = 0\end{matrix}$$

$$3. \{ \begin{matrix}d 8 ⊕ d 9 ⊕ p 5 ⊕ p 6 ⊕ p 10 ⊕ d 11 = 0 \\ d \text{?} ⊕ 2 d 9 ⊕ 3 p 5 ⊕ 4 p 6 ⊕ 5 d 10 ⊕ 6 d 11 = 0\end{matrix} .$$

$$\text{?} \text{indicates text missing or illegible when filed}$$

Based on equation (2), the calculation of the parity codes p1 to p6 can be performed, thus completing the encoding configuration of RAID6 in the example as shown in FIG. 3. In the situation of one or two errors, the decoding (degraded read) of RAID6 needs to fetch all the remaining data, as illustrated using the 2 in equation (2):
if d5 error is used as an example to illustrate the scenario of a single error:

$$d 5 = d 6 ⊕ d 7 ⊕ p 3 ⊕ p 4 ⊕ d 8 ; \qquad equation ( 3 )$$

and
if the d5d8 error is used as an example to illustrate the scenario of two errors:

$$d 5 = \frac{4}{5} d 6 ⊕ \frac{3}{\text{?}} d 7 ⊕ \frac{2}{5} p 3 ⊕ \frac{1}{5} p 4 \qquad equation ( 4 )$$

$$d 8 = \frac{1}{5} d 6 ⊕ \frac{2}{5} d 7 ⊕ \frac{3}{\text{?}} p 3 ⊕ \frac{4}{5} p 4.$$

$$\text{?} \text{indicates text missing or illegible when filed}$$

It can be determined from the equation (4) that, under traditional encoding and decoding methods, in the event of any (one or two) errors, the decoding of RAID6 needs to read and decode all the remaining data blocks. However, in a storage system, data reading is limited by a transmission channel and a protocol, which usually becomes the main limiting reasons for the speed of the operation; and therefore, the core of designing an advanced RAID6 solution is to consider how to reduce the amount of data read during encoding and decoding, thereby enhancing speed.

Second part: an optional implementation method of the encoding method for a RAID6 disk array provided in this embodiment is as follows:
the embodiment of the present disclosure improves the traditional encoding and decoding method for RAID6, and the encoding method thereof is improved as shown in FIG. 4:

### (1) Determination of the Number of Stripes

It is suggested in the embodiment of the present disclosure to perform stripe division to obtain an even number of stripes, thus achieving the maximum optimization effect. If the stripe division can be performed only to obtain an odd number of stripes based on practical requirements, the advantages of the embodiment of the present disclosure will be affected to some extent, but can still be implemented, and an odd number is optionally taken as an example for illustration, and the exemplary division is shown in FIG. 4.

(2) For the division of disks into two groups, labeled as groups A and B, the division method involves splitting the disks in half; and if the number of disks is an odd number n, the division results in two groups with numbers of

$$\frac{n + 1}{2} \text{?} \frac{n - 1}{2}$$

$$\text{?} \text{indicates text missing or illegible when filed}$$

respectively. The division of the two groups can be performed sequentially, with the same division applied to every two stripes. If the total number of stripes is an odd number, for the remaining last stripe, no division is carried out and encoding and decoding are performed by directly using a traditional RAID6 solution, as shown in “remaining odd stripe” example in FIG. 4. Therefore, after the described preparations are completed, the encoding configuration relationship of RAID6 is as shown in FIG. 4: for the current number of user disks n=6, based on the principle of splitting in half, the disks are divided into groups A and B with 3 disks each, and according to the sequential division principle, the A and B allocations for stripes 1 to 4 are as shown in FIG. 4. The encoding relationship of RAID6 of the embodiment of the present disclosure that is illustrated by taking stripe 1 and stripe 2 as an example is as follows:

$$\{ \begin{matrix}d 1 ⊕ d 2 ⊕ d 3 ⊕ d 4 ⊕ p 1 ⊕ p 2 = 0 \\ d 5 ⊕ 2 d 6 ⊕ 3 d 7 ⊕ 4 d 4 ⊕ 5 p 1 ⊕ 6 p 2 = 0 \\ d 5 ⊕ d 6 ⊕ d 7 ⊕ p 3 ⊕ p 4 ⊕ d 8 = 0 \\ d 1 ⊕ 2 d 2 ⊕ 3 d 3 ⊕ 4 p 3 ⊕ 5 p 4 ⊕ 6 d 8 = 0\end{matrix} . \qquad equation ( 5 )$$

It can be determined from equation (5) that the encoding parameter relationship of RAID6 is the same as the original RAID6 assignment method (Vandermonde), the first line of the equation of the encoding is the same, and the satisfaction condition of the second line of the equation, under the same parameter relationship, is adjusted to be AB group interleaving implementation. That is, in the encoding relationship of P1 and P2, the relationship in the first line is implemented using the original encoding relationship, and while the relationship in the second line is implemented using a cross-group method. For the event of an odd number of stripes, every two stripes form a relationship of the described equation (5), the remaining single stripe, as shown in the “remaining odd stripe” in FIG. 4, can be encoded using the original RAID6 encoding method, and stripes 3 and 4 have encoding methods similar to stripes 1 and 2.

Third part: an optional implementation method of the method for decrypting the RAID6 disk array provided in this embodiment is as follows:

(a) for decoding in the event of a single error, whether a disk where the error occurred is in group A or group B is firstly determined, all surviving (correct) data blocks in the group where the error occurred are read, and then the data blocks of the odd (or even) stripes from the other group are read, thus completing the decoding process. Taking the situation where an error occurs to disk1 in FIG. 4 as an example, as disk1 is in error, and it is within group B, all the data of disks 2 and 3 is read first. Then, the data of odd or even stripes of group A is selected for reading; when the odd-numbered stripes, which are stripes 1 and 3 of disks 4, 5 and 6, are read, it can be determined from equation (5) that the decoding method is as follows:

$$d \text{?} = \frac{d 2 ⊕ d 3 ⊕ d 4 ⊕ p 1 ⊕ p 2}{\text{?}} \qquad equation ( 6 )$$

$$d 5 = \frac{2 d 6 ⊕ 3 d 7 ⊕ 4 d 4 ⊕ 5 p 1 ⊕ 6 p 2}{\text{?}}$$

$$d 8 = \frac{d 9 ⊕ p 5 ⊕ p 6 \text{?} d 10 ⊕ d \text{?}}{\text{?}}$$

$$d \text{?} = \frac{\text{?} 3 p 8 ⊕ 4 p 6 ⊕ 5 d 10 \text{?} 6 d \text{?}}{\text{?}}$$

$$p 9 = p 10 \text{?} d 16 ⊕ d \text{?} d 18 \text{?} d 19.$$

$$\text{?} \text{indicates text missing or illegible when filed}$$

Similarly, when the even-numbered stripes are read, the described operation solution is:

$$d 1 = \frac{2 d 2 \text{?} 3 d 3 ⊕ 4 p 3 ⊕ 5 p 4 \text{?} 6 d 8}{\text{?}} \qquad equation ( 7 )$$

$$d \text{?} = \frac{d 6 ⊕ d 7 ⊕ p 3 ⊕ p 4 ⊕ d 8}{\text{?}}$$

$$d 8 = \frac{2 d 9 \text{?} 3 p 5 \text{?} 4 d 18 ⊕ 5 d 14 ⊕ 6 d 1 \text{?}}{\text{?}}$$

$$d \text{?} = \frac{p 2 ⊕ p 8 ⊕ d \text{?} ⊕ d 14 ⊕ d \text{?}}{\text{?}}$$

$$p 9 = p 10 ⊕ d 16 ⊕ d \text{?} ⊕ d 18 ⊕ d 19.$$

$$\text{?} \text{indicates text missing or illegible when filed}$$

It can be determined that when there is a single error, in the embodiment of the present disclosure, all data from the group where the error occurred is read, and additionally, for the data from the other group, only the data blocks from either the odd or even stripes need to be read; the decoding method is based on the relationship described in equation (5); and for different readings of odd or even stripes, it's only necessary to adjust the parameter relationships as shown in equations (6) and (7) (where the parameter relationships correspond to the solid or dashed lines in FIG. 4). During decoding, if the values to be decoded in a single stripe is decoded each time as in the normal decoding method of RAID6, the amount of data that needs to be read is equal to the amount of data required for the decoding of RAID6, and if the minimum decoding unit is two stripes, the amount of data that needs to be read can be reduced by half for the group of disks where no error occurred. With this implementation, assuming the number of stripes satisfying an even relationship is m and the number of disks satisfying an even relationship is n, the embodiment of the present disclosure for any single error recovery (degraded reading) scenario can reduce the number of data blocks that needs to be read by mn/4.

(b) In the event of any two errors, the decoding method is similar to the traditional decoding method of RAID6, it is required to read all the remaining data and then decoding is performed based on a method similar to the traditional decoding method of RAID6. For example, if errors occur on disks 1 and 2, the decoding method is as follows: for the scenario of two errors, because the solution of the embodiments of the present disclosure divides all data into two groups during encoding, there are two possible scenarios for two errors: both errors occur within the same group, or each error occurs in a different group. The following provides examples for each scenario.

b1: when two errors occur in the same group, the scenario where errors occur in disk 1 and disk 3 is used as an example for illustration. In this case, for taking the scenario where data blocks d1, d3, d5, and d7 have errors and need recovery as an example, the data relationship is as follows:

$$d 2 ⊕ d 4 ⊕ p \text{?} ⊕ p 2 = d \text{?} ⊕ d \text{?} \qquad equation ( 8 )$$

$$\text{?} ⊕ 4 p \text{?} ⊕ 5 p 4 ⊕ 6 p \text{?} = d \text{?} ⊕ 3 d 3$$

$$d 6 ⊕ p 3 ⊕ p 4 ⊕ d \text{?} = d \text{?} ⊕ d \text{?}$$

$$2 d 6 \text{?} 4 d 4 ⊕ 5 \text{?} 6 p \text{?} = \text{?} ⊕ 3 d \text{?} ;$$

$$\text{?} \text{indicates text missing or illegible when filed}$$

It can be determined from equation (8) that when errors occur in the four data blocks within the same group, a decoding relationship conforms to the decoding relationship of RAID6, but when decoding a single stripe, the amount of data read is greater than the amount of data of one stripe. However, as expressed in equation (8), when every two stripe are set as a minimum unit for decoding, the amount of data read is exactly the same as the traditional decoding of RAID6.

b2. When two errors occur in different groups, the scenario where errors occur on disks 1 and 4 is taken as an example for illustration. In this case, for taking the scenario where four data blocks d1, d4, d5 and p3 have errors and need recovery as an example, the data relationship is as follows:

$$1 : d 2 ⊕ d \text{?} ⊕ p \text{?} ⊕ p 2 = d \text{?} ⊕ d 4 \qquad equation ( 9 )$$

$$2 : 2 d 2 ⊕ 3 \text{?} ⊕ \text{?} p 4 ⊕ 6 d \text{?} = \text{?} ⊕ 4 p 3$$

$$3 : d 6 ⊕ d \text{?} ⊕ p 4 ⊕ p \text{?} = d \text{?} ⊕ p \text{?}$$

$$4 : 2 d 6 ⊕ \text{?} ⊕ 5 p \text{?} 6 p 2 = d \text{?} 4 d 4 ;$$

$$\text{?} \text{indicates text missing or illegible when filed}$$

For ease of description, the four relational equations in equation (9) are numbered as “1, 2, 3, 4”. It can be determined that, in this case, if a traditional operation method of RAID6 stripes is used, it would be impossible to perform decoding; and therefore, when two errors occur in different groups, two stripes are decoded in different groups each time, decoding is performed with two stripes as the minimum unit, and thus the relationship shown in equation (9) is obtained. In this case, elimination processing is performed on 1 and 2 based on d2, and elimination processing is performed on 3 and 4 based on d5 (the elimination processing in this step has only a unique solution, or elimination being performed on 2 and 3 and elimination being performed on 1 and 4), thereby obtaining:

$$d 2 ⊕ 2 d \text{?} ⊕ p \text{?} ⊕ p 2 ⊕ 5 p 4 ⊕ 6 p \text{?} = d 4 ⊕ \text{?} p 3 \qquad equation ( 10 )$$

$$d 6 ⊕ 2 d \text{?} ⊕ 5 p \text{?} ⊕ 6 p 2 ⊕ p 4 ⊕ p \text{?} = 4 d 4 ⊕ p 3 ;$$

$$\text{?} \text{indicates text missing or illegible when filed}$$

If the requirement for the polynomial to have a solution and to have a unique solution is satisfied, d4 and p3 can be decoded based on equation (10) using the method of RAID6, and similarly, d1 and d5 are obtained accordingly, thereby completing the decoding operations for all data. It can be determined that the amount of data read in this case is the same as that in the traditional method of RAID6.

In conclusion, according to the solution provided in the embodiments of the present disclosure, when decoding is performed, the minimum decoding unit is changed to an even number of stripes, so that the requirement for the amount of data block read being reduced by mn/4 (the number of stripes satisfying an even number relationship is m, and the number of disks satisfying an even number relationship is n) when there is a single error can be satisfied; and when there are two errors, the amount of date read during decoding is the same as that of RAID6. In addition, for the stripes that do not conform to an even number of stripes (the remaining one stripe in the case of odd numbers), the traditional operations of RAID6 are used; and in the implementation architecture of the embodiment of the present disclosure, although operations are performed with a minimum unit of two stripes each time, in this case, the operation for the remaining stripe is performed by padding with 0. In practical scenarios, stripe division is determined by design, and therefore this case usually does not occur.

According to the encoding method for a RAID6 disk array and the decoding method for a RAID6 disk array in the embodiments of the present disclosure, when a single error occurs, the amount of data read for recovery can be reduced by about half, thereby achieving the advantage of increasing the speed by about one time; and during encoding or double error decoding, by means of pipeline reuse, the actual speed can reach the characteristic of standard RAID6, thereby achieving the improvement in decoding speed for a single error with relatively small loss.

In still another embodiment, referring to FIG. 5, an embodiment of the present disclosure further provides an encoding apparatus 300 for a RAID6 disk array, wherein the encoding apparatus 300 comprises:
a disk grouping module 301, configured to divide all disks in a RAID6 disk array into two groups to obtain a first disk group and a second disk group;
a stripe pairing module 302, configured to pairing all stripes of the RAID6 disk array to obtain several stripe pairs; and
a calculation module 303, configured to calculate two parity codes of each strip in the N stripe pairs according to a first rule and a second rule, wherein the first rule is that the result of XOR operations on each piece of data from the first disk group and each piece of data from the second disk group in each stripe is equal to zero, and the second rule is that the result of XOR operations on the product of each piece of data from the first disk group multiplied by the corresponding disk number in one stripe of a stripe pair, and the product of each piece of data from the second disk group multiplied by the corresponding disk number in the other stripe of the same stripe pair, is equal to zero.

By using the encoding apparatus 300 for a RAID6 disk array, all disks in a RAID6 disk array are divided into two groups to obtain a first disk group and a second disk group; all stripes of the RAID6 disk array are paired to obtain several stripe pairs; and finally two parity codes of each strip in the several stripe pairs are calculated according to a first rule and a second rule. This apparatus enables cross-coding of two stripes belonging to the same stripe pair based on disk grouping, enriching the encoding and decoding methods of RAID 6 disk arrays, reducing the amount of data required to be read for data recovery in the event of a single disk error, and enhancing the performance of RAID6.

In some embodiments, the encoding apparatus 300 further comprises:
in response to the total number of stripes in the RAID6 disk array being an odd number, calculating two parity codes of an unpaired stripe according to a first rule and a third rule, wherein the third rule is that the result of XOR operations on the product of each piece of data from the first disk group multiplied by the corresponding disk number and the product of each piece of data from the second disk group multiplied by the corresponding disk number in the same stripe is equal to zero.

In some embodiments, the disk grouping module 301 is configured to:
acquire the total number of disks of the RAID6 disk array;
in response to the total number of disks being an even number, equally divide all disks constituting the RAID6 disk array into two groups; and
in response to the total number of disks being an odd number, divide all disks constituting the RAID6 disk array into two groups, with one group containing one more disk than the other.

In some embodiments, the disk grouping module 301 is configured to:
acquire the disk arrangement sequence of the RAID6 disk array; and
divide the first half and the second half of the disk arrangement sequence into separate groups.

The disk grouping module 301 is configured to:
acquire the disk arrangement sequence of the RAID6 disk array; and
divide the disks corresponding to all odd-numbered positions and the disks corresponding to all even-numbered positions in the disk arrangement sequence into two groups.

In some embodiments, the disk grouping module 301 is configured to:
acquire the disk arrangement sequence of the RAID6 disk array; and
divide the disks corresponding to all odd-numbered positions and the disks corresponding to all even-numbered positions in the disk arrangement sequence into two groups.

In some embodiments, the stripe pairing module 302 is configured to:
acquire the total number of stripes and the stripe arrangement sequence of the RAID6 disk array;
in response to the total number of the stripes being an even number, pair all the stripes based on the stripe arrangement sequence in a manner where every two consecutive stripes form a pair; and
in response to the total number of the strips being odd, pair the remaining stripes, excluding the first or last stripe, based on the stripe arrangement sequence in a manner where every two consecutive stripes form a pair.

In some embodiments, the load balancing of the RAID6 disk array can be achieved in any of the following ways: left rotation alignment, left rotation misalignment, right rotation alignment, and right rotation misalignment.

It is noted that, for the definition of an encoding apparatus for a RAID6 disk array, reference may be made to the described definition of the encoding method for a RAID6 disk array, and details are not repeatedly described herein. All or a part of the modules in the described encoding apparatus for a RAID6-disk array may be implemented by software, hardware, or a combination thereof. The described modules may be embedded in or independent from a processor in a computer device in a hardware form, and may also be stored in a memory in the computer device in a software form, so that the processor invokes and executes operations corresponding to the described modules.

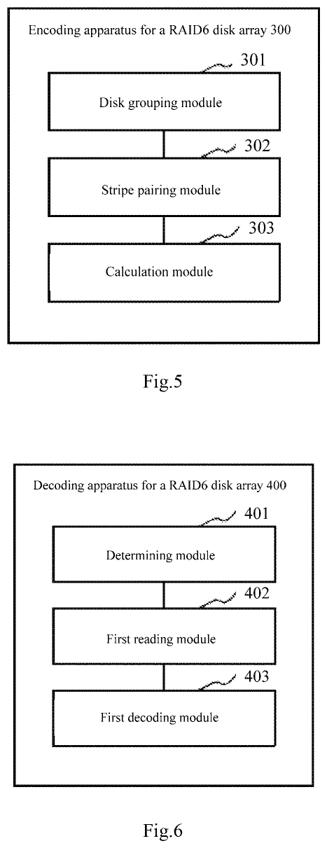

In still another embodiment, referring to FIG. 6, an embodiment of the present disclosure further provides a decoding apparatus 400 for a RAID6 disk array, wherein the RAID6 disk array is encoded by using the described encoding apparatus, and the decoding apparatus 400 comprises:
a determining module 401, configured to, in response to a single disk error occurring in the RAID6 disk array, determine the disk group to which the single disk error belongs;
a first reading module 402, configured to, in response to the stripe corresponding to the single disk error belonging to the N stripe pairs, read first decoded data in a manner where the minimum decoding unit consists of two stripes, wherein N is a positive integer greater than or equal to 2, and the first decoded data comprises: all data from the other disks in the disk group to which the single disk error belongs, where the single disk error did not occur, on both stripes of one stripe pair, as well as all data from each disk in the disk group where the single disk error did not occur, on one stripe of the same stripe pair; and
a first decoding module 403 configured to perform decoding based on the first rule, the second rule, and the first decoded data to obtain recovered data.

The described decoding apparatus 400 for a RAID6 disk array allows for the recovery of erroneous data without the need to read all the data in the event of a single disk error, reduce the amount of data required to be read for data recovery in the event of a single disk error, thereby enhancing RAID6 performance.

In some examples, the decoding apparatus 400 further comprises:
a second reading module, configured to, in response to the stripe corresponding to the single disk error not belonging to any stripe pair, second decoded data is read in a manner where the minimum decoding unit consists of one stripe, wherein the second decoded data comprises all data from the other disks, excluding the disk where the single disk error occurred, on the stripe; and
a second decoding module, configured to perform decoding based on the first rule, the third rule, and the second decoded data to obtain recovered data.

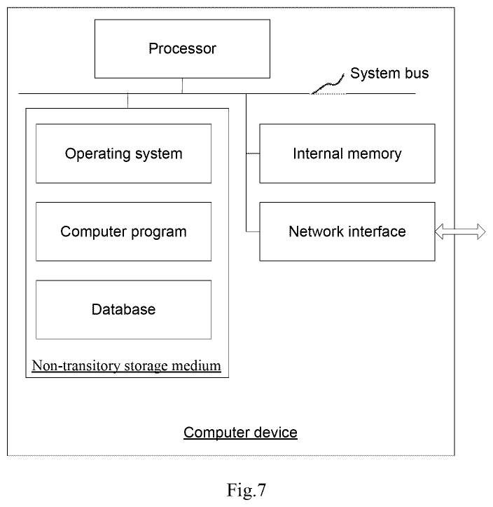

According to another aspect of the embodiments of the present disclosure, a computer device is provided. The computer device may be a server. Please refer to FIG. 7 for an internal structure diagram of the computer device. The computer device comprises a processor, a memory, a network interface, and a database connected by a system bus. The processor of the computer device is configured to provide computational and control capabilities. The memory of the computer device comprises a non-volatile storage medium and an internal memory. The non-volatile storage medium stores an operating system, a computer program, and a database. The internal memory provides an environment for running of the operating system and the computer program in the non-volatile storage medium. The database of the computer device is used for storing data. The network interface of the computer device is configured to communicate with an external terminal through a network connection. The computer program implements, when being executed by a processor, the described encoding method for a RAID6 disk array or decoding method for a RAID6 disk array.

According to another aspect of the embodiments of the present disclosure, a non-volatile readable storage medium is provided, wherein a computer program is stored on the non-volatile readable storage medium, and the computer program when being executed by a processor, implements the described encoding method for a RAID6 disk array or decoding method for a RAID6 disk array.

A person skilled in the art may understand that all or a part of the processes of the methods in the described embodiments may be implemented by a computer program instructing relevant hardware. The computer program may be stored in a non-transitory computer readable storage medium. The computer program, when being executed, may implement the processes of the methods in the described embodiments. Any reference to memory, storage, database, or other media used in the embodiments of the present disclosure may include non-volatile and/or volatile memory. The non-volatile memory may include read only memory (ROM), programmable ROM (PROM), electrically programmable ROM (EPROM), electrically erasable programmable ROM (EEPROM), or flash memory. The volatile memory may include random access memory (RAM) or external high-speed cache memory. By way of illustration and not limitation, RAM is available in various forms, such as Static RAM (SRAM), Dynamic RAM (DRAM), Synchronous DRAM (SDRAM), Double Data Rate SDRAM (DDR SDRAM), Enhanced SDRAM (ESDRAM), Synchlink DRAM (SLDRAM), Rambus Direct RAM (RDRAM), Direct Rambus DRAM (DRDRAM), and Rambus Dynamic RAM (RDRAM), among others.

The various technical features of the described embodiments may be combined in any way. For brevity of description, not all possible combinations of the technical features in the described embodiments have been described. However, as long as combinations of these technical features are not contradictory, all these technical features is considered to belong to the scope of the present description.

The described embodiments merely express several implementations of the embodiments of the present disclosure, and the descriptions thereof are relatively rich and detailed, but are not intended to limit the scope of the present disclosure. It is noted that, for a person skilled in the art, various modifications and improvements may be made without departing from the concept of the embodiments of the present disclosure, and all these modifications and improvements belong to the scope of protection of the embodiments of the present disclosure. Therefore, the scope of protection of the embodiments of the present disclosure shall be subject to the appended claims.

1. An encoding method for a RAID6 disk array, comprising:
dividing all disks in a RAID6 disk array into two groups to obtain a first disk group and a second disk group;
pairing all stripes of the RAID6 disk array to obtain N stripe pairs, wherein N is a positive integer greater than or equal to 2; and
calculating two parity codes of each strip in the N stripe pairs according to a first rule and a second rule, wherein the first rule is that the result of XOR operations on each piece of data from the first disk group and each piece of data from the second disk group in each stripe is equal to zero, and the second rule is that the result of XOR operations on the product of each piece of data from the first disk group multiplied by the corresponding disk number in one stripe of a stripe pair, and the product of each piece of data from the second disk group multiplied by the corresponding disk number in the other stripe of the same stripe pair, is equal to zero.

2. The encoding method for a RAID6 disk array according to claim 1, wherein the encoding method further comprises:
in response to the total number of stripes in the RAID6 disk array being an odd number, calculating two parity codes of an unpaired stripe according to the first rule and a third rule, wherein the third rule is that the result of XOR operations on the product of each piece of data from the first disk group multiplied by the corresponding disk number and the product of each piece of data from the second disk group multiplied by the corresponding disk number in the same stripe is equal to zero.

3. The encoding method for a RAID6 disk array according to claim 1, wherein the dividing all disks in a RAID6 disk array into two groups to obtain a first disk group and a second disk group comprises:
acquiring the total number of disks of the RAID6 disk array;
in response to the total number of disks being an even number, equally dividing all disks constituting the RAID6 disk array into two groups; and
in response to the total number of disks being an odd number, dividing all disks constituting the RAID6 disk array into two groups, with one group containing one more disk than the other.

4. The encoding method for a RAID6 disk array according to claim 3, wherein the equally dividing all disks constituting the RAID6 disk array into two groups comprises:
acquiring the disk arrangement sequence of the RAID6 disk array; and
dividing the first half and the second half of the disk arrangement sequence into separate groups.

5. The encoding method for a RAID6 disk array according to claim 3, wherein the equally dividing all disks constituting the RAID6 disk array into two groups comprises:
acquiring the disk arrangement sequence of the RAID6 disk array; and
dividing the disks corresponding to all odd-numbered positions and the disks corresponding to all even-numbered positions in the disk arrangement sequence into two groups.

6. The encoding method for a RAID6 disk array according to claim 3, wherein the dividing all disks constituting the RAID6 disk array into two groups, with one group containing one more disk than the other comprises:
acquiring the disk arrangement sequence of the RAID6 disk array; and
dividing the disks corresponding to all odd-numbered positions and the disks corresponding to all even-numbered positions in the disk arrangement sequence into two groups.

7. The encoding method for a RAID6 disk array according to claim 1, wherein the step of pairing all stripes of the RAID6 disk array to obtain N stripe pairs comprises:
acquiring the total number of stripes and the stripe arrangement sequence of the RAID6 disk array;
in response to the total number of the stripes being an even number, pairing all the stripes based on the stripe arrangement sequence in a manner where every two consecutive stripes form a pair; and
in response to the total number of the strips being odd, pairing the remaining stripes, excluding the first or last stripe, based on the stripe arrangement sequence in a manner where every two consecutive stripes form a pair.

8. The encoding method for a RAID6 disk array according to claim 1, wherein the load balancing of the RAID6 disk array can be achieved in any of the following ways: left rotation alignment, left rotation misalignment, right rotation alignment, and right rotation misalignment.

9. The encoding method for a RAID6 disk array according to claim 1, wherein the calculating two parity codes of each strip in the N stripe pairs according to a first rule and a second rule comprises:
calculating two parity codes of each stripe in the N stripe pairs according to the first rule and the second rule, and ensuring that the two stripes belonging to the same stripe pair are cross-coded according to disk grouping.

10. A decoding method for a RAID6 disk array, wherein the RAID6 disk array is encoded by using the encoding method according to claim 1, and the decoding method comprises:
in response to a single disk error occurring in the RAID6 disk array, determining the disk group to which the single disk error belongs;
in response to the stripe corresponding to the single disk error belonging to the N stripe pairs, reading first decoded data in a manner where the minimum decoding unit consists of two stripes, wherein N is a positive integer greater than or equal to 2, and the first decoded data comprises: all data from the other disks in the disk group to which the single disk error belongs, where the single disk error did not occur, on both stripes of one stripe pair, as well as all data from each disk in the disk group where the single disk error did not occur, on one stripe of the same stripe pair; and
performing decoding based on the first rule, the second rule, and the first decoded data to obtain recovered data.

11. The decoding method for a RAID6 disk array according to claim 10, wherein the decoding method further comprises:
in response to the stripe corresponding to the single disk error not belonging to any stripe pair, reading second decoded data in a manner where the minimum decoding unit consists of one stripe, wherein the second decoded data comprises all data from the other disks, excluding the disk where the single disk error occurred, on the stripe; and
performing decoding based on the first rule, the third rule, and the second decoded data to obtain recovered data.

12. The decoding method for a RAID6 disk array according to claim 10, wherein the decoding method further comprises:
in response to two disk errors occurring in the RAID6 disk array, determining the disk groups to which the two disk errors belong;
when the two disk errors belong to the same disk group, reading third decoded data in a manner where the minimum decoding unit consists of two stripes, wherein the third decoded data comprises: all data from the other disks in the disk group to which the two disk errors belong, where the two disk errors did not occur, on both stripes of one stripe pair, as well as all data from each disk in the disk group where the two disk errors did not occur, on one stripe of the same stripe pair;
performing decoding based on the first rule, the second rule, and the third decoded data to obtain recovered data.

13. The decoding method for a RAID6 disk array according to claim 12, wherein the decoding method further comprises:
when the stripes corresponding to the two disk errors belong to different disk groups, reading fourth decoded data in a manner where the minimum decoding unit consists of two stripes, wherein the fourth decoded data comprises all data from the other disks, excluding the disks where the two disk errors occurred, on both stripes of one stripe pair;
performing decoding based on the first rule, the third rule, and the fourth decoded data to obtain recovered data.

14. The decoding method for a RAID6 disk array according to claim 10, wherein the first rule is that the result of XOR operations on each piece of data from the first disk group and each piece of data from the second disk group in each stripe is equal to zero.

15. The decoding method for a disk array according to claim 10, wherein the second rule is that the result of XOR operations on the product of each piece of data from the first disk group multiplied by the corresponding disk number in one stripe of a stripe pair, and the product of each piece of data from the second disk group multiplied by the corresponding disk number in the other stripe of the same stripe pair, is equal to zero.

16. The decoding method for a RAID6 disk array according to claim 11, wherein the third rule is that the result of XOR operations on the product of each piece of data from the first disk group multiplied by the corresponding disk number and the product of each piece of data from the second disk group multiplied by the corresponding disk number in the same stripe is equal to zero.

17. An encoding apparatus for a RAID6 disk array, comprising:
a disk grouping module, configured to divide all disks in a RAID6 disk array into two groups to obtain a first disk group and a second disk group;
a stripe pairing module, configured to pairing all stripes of the RAID6 disk array to obtain N stripe pairs, wherein N is a positive integer greater than or equal to 2; and
a calculation module, configured to calculate two parity codes of each strip in the N stripe pairs according to a first rule and a second rule, wherein the first rule is that the result of XOR operations on each piece of data from the first disk group and each piece of data from the second disk group in each stripe is equal to zero, and the second rule is that the result of XOR operations on the product of each piece of data from the first disk group multiplied by the corresponding disk number in one stripe of a stripe pair, and the product of each piece of data from the second disk group multiplied by the corresponding disk number in the other stripe of the same stripe pair, is equal to zero.

18. A decoding apparatus for a RAID6 disk array, wherein the RAID6 disk array is encoded by using the encoding apparatus as claimed in claim 17, and the decoding apparatus comprises:
a determination module, configured to, in response to a single disk error occurring in the RAID6 disk array, determine the disk group to which the single disk error belongs;
a first reading module, configured to, in response to the stripe corresponding to the single disk error belonging to the N stripe pairs, read first decoded data in a manner where the minimum decoding unit consists of two stripes, wherein N is a positive integer greater than or equal to 2, and the first decoded data comprises: all data from the other disks in the disk group to which the single disk error belongs, where the single disk error did not occur, on both stripes of one stripe pair, as well as all data from each disk in the disk group where the single disk error did not occur, on one stripe of the same stripe pair; and
a first decoding module, configured to perform decoding based on the first rule, the second rule, and the first decoded data to obtain recovered data.

19. A computer device, comprising:
at least one processor; and
a memory, wherein the memory stores a computer program that is executable by the processor, and when the computer program is executed by the at least one processor, cause the at least one processor to perform the encoding method as claimed in claim 1.

20. A non-transitory computer-readable storage medium, wherein the non-transitory computer readable storage medium stores a computer program, wherein the computer program is configured to, when executed by a processor, cause the processor to perform the encoding method as claimed in claim 1.
